(19) United States
(12) Patent Application Publication
(10) Pub. No.: US 2019/0070996 A1
(43) Pub. Date: Mar. 7, 2019

(54) CARGO HOLD EXTENDER

(71) Applicant: Quick Extend-A-Bed, LLC, Bellflower, CA (US)

(72) Inventors: Richard James Waitneight, Newport Beach, CA (US); Larry A. Quick, Aneheim, CA (US)

(21) Appl. No.: 16/119,134

(22) Filed: Aug. 31, 2018

Related U.S. Application Data
(60) Provisional application No. 62/553,720, filed on Sep. 1, 2017.

(51) Int. Cl. B60P 3/40

(52) U.S. Cl. CPC B60P 3/40

(57) ABSTRACT

A cargo hold extender can include a plurality of folding walls. The plurality of folding walls can be folded into a stowed position contained entirely within a cargo hold of a hatched vehicle. The plurality of walls can also be moved to an extended position in which the plurality of folding walls extend outwardly through an aperture of a hatch of the hatched vehicle supported by a mounting mechanism mounted within the cargo hold. The plurality of folding walls can be deployed and connected with the hatch of the vehicle, thus forming an extended cargo hold for a hatched vehicle.

### REFERENCE TO RELATED APPLICATIONS

Any and all applications for which a foreign or domestic priority claim is identified in the Application Data Sheet as filed with the present application are hereby incorporated by reference under 37 CFR 1.57.

### FIELD OF THE INVENTIONS

The present inventions relate to extenders for cargo holds, an in particular, extenders designed to create an enclosed space extending through a hatch of an enclosed cargo hold.

### BACKGROUND OF THE INVENTIONS

Some vehicles include enclosed cargo areas or cargo holds having a hatch. For example, automobiles known as “hatch backs” and “sports utility vehicles” (SUVs) include enclosed volumes of space in the rear of the vehicle. Typically, these vehicles include a hinged hatch attached to the upper area or roof of the vehicle. The hinge hardware allows the hatch to pivot upwardly between a closed position and an open period.

Occasionally, an owner of such a vehicle can encounter the need to transport an item or a total amount of items that occupy a greater volume of space than the interior volume of the enclosed cargo area of the vehicle. In such situations, the vehicle user may choose to put the items on the roof of the vehicle, on a tray attachable to a rear of the vehicle, in a trailer, or in another vehicle.

### SUMMARY OF THE INVENTIONS

An aspect of at least one of the inventions disclosed herein includes the realization that an extender apparatus can be used to extend the size of our cargo area, such as that of a hatched vehicle, using a folding plurality of walls that can be extended through a hatch opening of such a vehicle. For example, hatch backs or SUVs typically include an enclosed cargo area, oftentimes positioned rearward of rear seats of the vehicle. Such cargo areas include a floor and a hatch pivotally mounted relative to a hatch aperture.

In some embodiments, a cargo hold extender can include a set of folding walls mounted to be movable between a stowed position entirely within the cargo hold and an extended position in which the plurality of walls extend through the hatch aperture the cargo hold. The plurality of walls can be unfolded to a deployed state defining an extended volume supplementing the total volume of the cargo hold. The plurality of walls, in the deployed position, can cooperate with the hatch of the vehicle so as to form a fully enclosed auxiliary portion of the cargo hold.

In some embodiments, a cargo area extender can include a plurality of walls folded into a stowed position. The plurality of walls can be mounted to a floor of a cargo hold of a vehicle with a pivot. The pivot can allow the plurality of walls, in the stowed position, to be pivoted upwardly so as to provide access to a space beneath the plurality of folded walls. For example, some vehicles can include equipment disposed beneath a floor of the cargo hold, such as a spare tire, jack, tools, etc. Thus, mounting the plurality of walls of a cargo hold extender to the cargo hold with a pivot, allows for access to such equipment without uninstallation of the plurality of walls.

In some embodiments, the cargo hold extender can include a floor member fixed above the plurality of walls in the stowed position. Thus, the floor member can provide a fixed support surface defining a bottom of the cargo hold which is undisturbed by the movement of the set of foldable walls into and out of the hatch aperture. Further, in some embodiments, both the floor member and the set of foldable walls can be mounted to the cargo hold with a pivot, for providing access to equipment disposed below the cargo hold extender.

Another aspect of at least one of the inventions disclosed herein includes the realization that the cargo hold extender can be configured to lock to a locking mechanism on the hatch of a hatched cargo hold. For example, a cargo hold extended can include a rear wall with an upper edge. A lock post can be mounted to the upper edge of the rear wall and configured to engage a hatch lock on the lower portion of the hatch of hatched vehicle. As such, the hatch itself, by way of the hatch lock on the hatch can be used to assist in securing the cargo hold extender in place during use. In some embodiments, the post can be in a form of a loop.

Other objects and advantages of the inventions disclosed herein are apparent from the following description taken in connection with the accompanying drawings, which is set forth in a way of illustration and example, embodiments of these inventions.

### BRIEF DESCRIPTION OF THE DRAWINGS

FIG. 1 is a schematic side elevational view of a vehicle with a hatched cargo hold and an embodiment of a cargo hold extender disposed therein, illustrated in phantom line.

FIG. 2 is a schematic side elevational view of the vehicle and extender of FIG. 1, with the hatch in the open position, and the cargo hold extender in a deployed position.

FIG. 3 is a further schematic side elevational view of the vehicle and cargo hold extender of FIGS. 1 and 2 with the hatch of the vehicle engaged with the cargo hold extender.

FIG. 4 is a schematic perspective view of a vehicle having an enclosed, hatched cargo hold with the hatch in an open position and another embodiment of the cargo hold extender, in a stowed position, mounted within the cargo hold of the vehicle.

FIG. 5 is a perspective view of the embodiment of FIG. 4 with a set of folding walls of the cargo hold extender moved to an extended position.

FIG. 6 is a further perspective view of the embodiment of FIG. 4, with side walls of the cargo hold extender disposed in a deployed position and a rear wall of the cargo hold extender illustrated in an extended position (in phantom line).

FIG. 7 is a further perspective view of the embodiment of FIG. 4, with the rear wall moved to a deployed position and attached to the side walls, and with the deployed plurality of folding walls pushed into a position engaged with the hatch aperture of the vehicle.

FIG. 8 is a perspective view of the embodiment of FIGS. 4-7 with the hatch of the vehicle engaged with the cargo hold extender.

FIG. 9 is another perspective view of the embodiment of FIGS. 4-8 illustrating the cargo hold extender in stowed position and pivoted upwardly from a resting position.

FIG. 10 is a partially exploded and perspective view of the cargo hold extender of FIGS. 4-9 with the plurality of folding walls extender in an extended and deployed position.

FIG. 11 is an enlarged side elevational view a linear guide mechanism of the cargo hold extender in an extended state.

FIG. 12 is an enlarged side elevational view of a liner guide mechanism of the cargo hold extender in a retracted state.

FIG. 13 is a rear elevational view of the cargo hold extender in a stowed state.

FIG. 14 is a side elevational view of the cargo hold extender in a folded and extended state.

FIG. 15 is a side elevational view of the cargo hold extender in a deployed and engaged state.

FIG. 16 is an enlarged top plan view of a corner of the cargo hold extender illustrating a latching mechanism connecting a side wall and rear wall of the cargo hold extender.

FIG. 17 is an enlarged side elevational view of the cargo hold extender in an extended position.

FIG. 18 is an enlarged side elevational view of the cargo hold extender illustrating an alignment of alignment post and alignment apertures for aligning side and rear walls of the cargo hold extender.

FIG. 19 is an enlarged perspective view of a locking mechanism for locking the cargo hold extender in an extended and deployed position.

FIG. 20 is an enlarged perspective view of a portion of the linear guide mechanism of the cargo hold extender.

FIG. 20A is an enlarged rear elevational view of the linear guide mechanism of FIG. 20.

### DETAILED DESCRIPTION

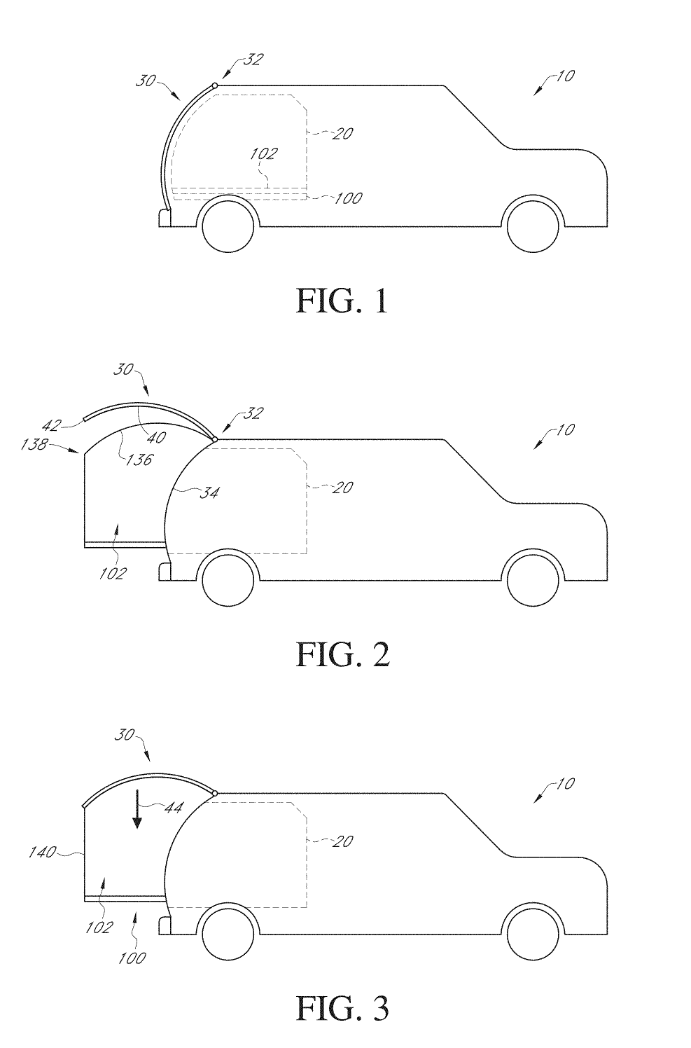

Embodiments of a cargo hold extender are described below in detail reference to FIGS. 1-20A of the accompanying drawings. The embodiments of the cargo hold extender are disclosed in the context of an extender of the cargo area of a hatched vehicle, such as a sports utility vehicle (“SUV”), because they have particular utility in that context. However, the inventions disclosed herein can be used in other contexts, for example, hatch back vehicles, trailers, and other hatched cargo holds.

With reference to FIGS. 1-3, a vehicle 10 can include an enclosed cargo hold 20. For example, the vehicle 10 can be in the form of a SUV which typically includes two or more rows of seats for passengers and a dedicated space at the rear of the vehicle for cargo, referred to herein as a cargo hold 20.

The cargo hold 20 may be a fully or semi-partitioned portion of the interior space of the vehicle 10. For example, in many SUVs, the cargo hold 20 is a space behind the rear-most seats of the vehicle 10. Thus, a forward most wall of the cargo hold 20 can be considered as being formed by the seat backs of the rearward-most row of seats in the vehicle 10. However, the hold 20 is open in the area above the tops of the seat backs. As used herein, despite the open portion described above, the cargo hold 20 is referred to herein as an enclosed cargo hold or “cargo area”.

As is typical of many SUVs, the vehicle 10 includes a hatch 30. The hatch 30 is hingedly engaged with an upper portion or roof of the vehicle by hinge assembly 32. Thus, the hatch 30 is pivotable in a closed position (FIG. 1) and an open position (FIG. 2) through a pivoting motion about the hinge 32. In the closed position, the hatch 30 seals or substantially seals against a hatch aperture 34. The hatch aperture 34 and a corresponding peripheral portion of the hatch 32 can include various contours that are complimentary to each other. Some vehicles include gaskets for enhancing a seal between the hatch 30 and the hatch aperture 34.

As illustrated in FIGS. 1-3, the vehicle 10 includes a cargo hold extender 100. The cargo hold extender can include a set of folding walls 102 that can be mounted to and stowed within the cargo hold 20 in a folded state. In some embodiments, the overall size of the set of folding walls 102 is sufficiently small, in the folded state, to fit entirely within the cargo hold 20 with the hatch 30 in the closed position (FIG. 1).

In some embodiments, the set of folding walls 102 is configured to be movable from the stowed position illustrated in FIG. 1, to an extended position illustrated in FIG. 2 in which the plurality of folded walls extends through the hatch aperture 34.

Further, some embodiments, as illustrated in FIG. 3, the upper edges of the set of folding walls, identified generally by the reference numerals 136 and 138, can include shapes that are complimentary to corresponding surfaces of the hatch, identified generally by the reference numerals 40 and 42. The complimentary surfaces 36, 38, 40, 42 can be configured to abut one another when the hatch 30 is pressed downwardly, in the direction of arrow 44 in FIG. 3 such that the hatch 30 and the cargo hold extender 100 generally form an extended and enclosed additional volume of the original cargo hold 20, with the hatch 30 acting as a top wall of the cargo hold extender 100. In some embodiments, a rear wall 140 of the extender 100 can include a locking member (not shown) configured to cooperate with a lock (not shown) of the hatch 30.

For example, when the hatch 30 is pressed downwardly in the direction of arrow 44 (FIG. 3) the lock on the hatch 30 can lock to the lock device on the rear wall 140. As such, the hatch 30 itself can provide a structural support for securing the cargo hold extender 100 in position during use.

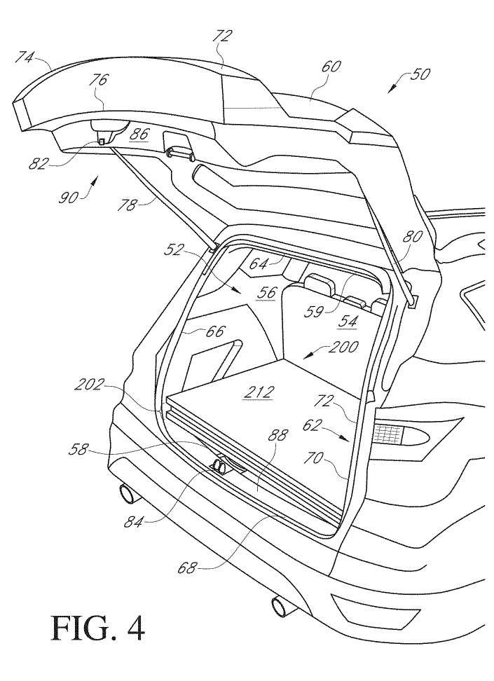

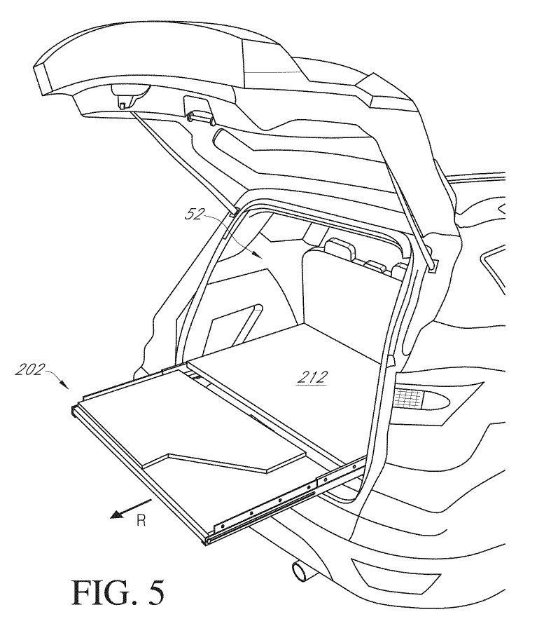

With reference to FIG. 4-20, further embodiments of the cargo hold extender 100 are illustrated therein and identified generally by the reference numeral 200. The description set forth above with reference to the embodiment of the cargo hold extender 100 illustrated in FIGS. 1-3 was equally to the embodiment of the cargo hold extender 200, except as expressly explained below.

With reference to FIG. 4, a vehicle 50 can include an enclosed cargo hold 52. As with vehicle 10 and the cargo hold 20, the cargo hold 52 is defined in a rear section of the vehicle 50, behind a row of seats 54. More specifically, the rearward facing surfaces of the backs of the row of seats 54 defines a forward-most wall of the cargo hold 52. Although this forward most wall does not extend entirely to the top of the cargo hold 52, the cargo hold 52 is considered to be closed cargo hold 52. In some vehicles 50, the row of seats 54 can be folded forwardly, thereby expanding the size of the cargo hold 52.

The cargo hold 52 includes left and right side walls 56 (only the left side wall 56 is illustrated). A bottom surface 58 and an upper surface 59 defined by a roof of the vehicle 50. When in a closed position, a hatch 60 forms a rear wall of the cargo hold 52. Thus, the cargo hold 52 can be considered as a hatched cargo hold or a vehicle with a hatched cargo hold. The vehicle 50 can also be referred to as in “hatched vehicle.”

The cargo hold 52 also includes a hatch aperture 62 which extends around the periphery of a rear portion of the cargo hold 52. The hatch aperture 62 includes an upper edge 64, a left side edge 66, a bottom edge 68, and right side edge 70. A gasket 72 extends around an entire periphery of the hatch aperture 62, and along all of the edges 64, 66, 68, and 70. Such gaskets are well known in the art.

The hatch 60 is configured to form a substantially continuous seal with the hatch aperture 62. On its exterior, the hatch 60 includes an outer surface 72 having shapes and contours designed to provide aerodynamics and aesthetic appeal with the remainder of the outer surface of the vehicle 50.

On an inner side, the hatch 60 includes a peripheral flanged portion 74 that extends around substantially the entire periphery of the hatch 60. The hatch 60 can also include a sealing surface 76 extending around the hatch 60, facing inwardly toward the gasket 72. The sealing surface 76 is configured to the pressed against and seal against the gasket 72 when hatch 60 is in the closed position. The contact between the sealing surface 76 and the gasket 72 provides for insulation for the vehicle 50, reducing the amount of noise and air that flows into the vehicle 50 through the hatch 60. Additionally, the interior of the hatch 60 can include insulation and typically includes a rear facing window.

The hatch 60 can be attached to an upper portion of vehicle 50 with hinges (not shown). Additionally, the vehicle 50 can include dampers 78, 80 for dampening movement of the hatch 60 about its pivoting access. The dampers 78, 80 can also be preloaded, for example with compressed air, to assist in the opening of the hatch 60. Other devices can also be used for attaching the hatch 60 to the vehicle 50.

The hatch 60 can also include a lock mechanism 82. The lock mechanism typically includes a manual or powered latch configured to capture a post 84 mounted to a sill portion adjacent to the hatch aperture 62. In some vehicles, the post 84 is a loop. As is typical with many designs of vehicles, the hatch 60 includes various other overlapping surfaces, such as the surface 86 which projects inwardly, beyond the hatch aperture 62, partly into the internal volume of the cargo hold 200. Specifically, the surface 86, when the hatch 60 is in a closed position (not shown), overlaps the sill 88 of the vehicle 50. Other portions of the interior's side of the hatch 60 may also project inwardly into the cargo hold 52 beyond the hatch aperture 62. Thus, the inner side 90 of the hatch 60 can have various different contours along the surfaces which face toward the cargo hold 52.

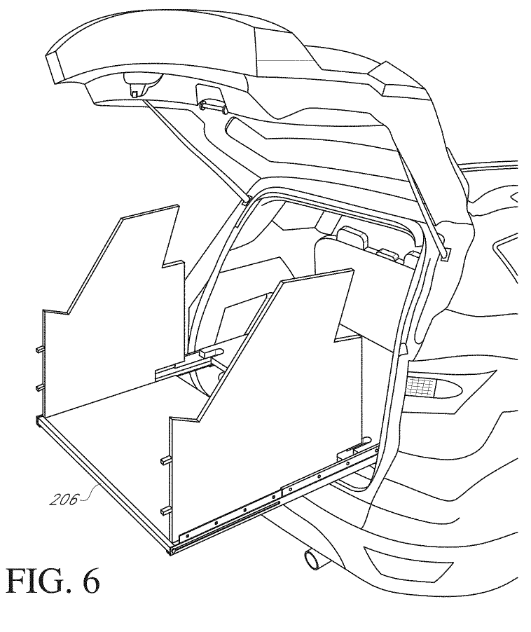

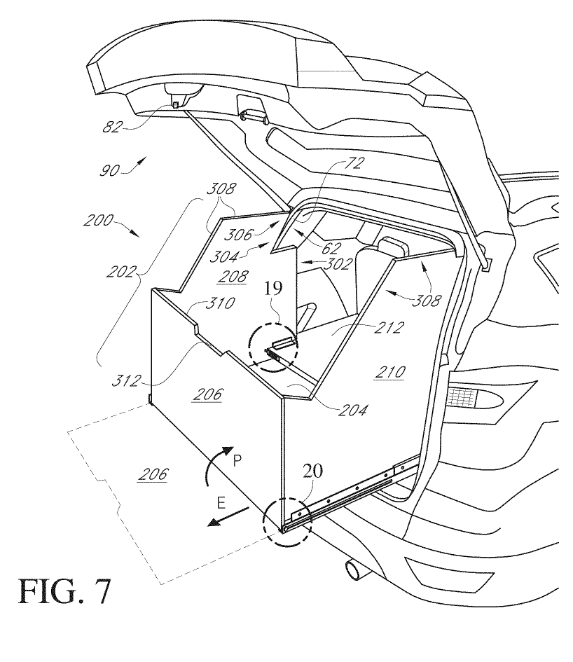

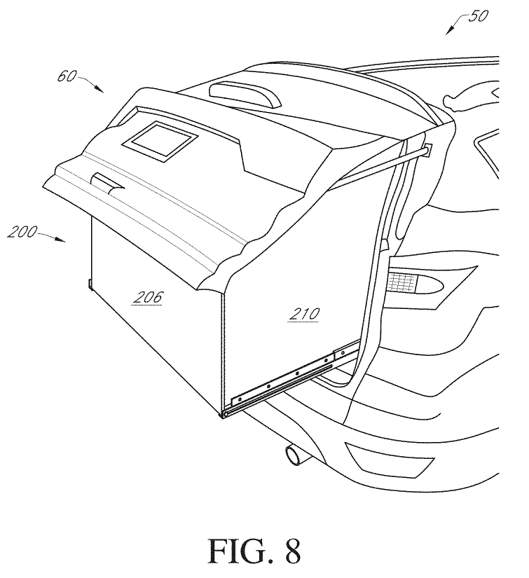

With continued reference to FIG. 4, the cargo hold extender 200 can include a plurality of folding walls 202 configured to the movable from a stowed position (FIG. 4) to an extended position (FIG. 5) and unfolded (FIG. 6) to a deployed position (FIG. 7). In the deployed position (FIG. 7), the hatch 60 can be lowered onto the upper edges of the extender 200 and thereby form an enclosed extension of the vehicle's cargo hold 52 (FIG. 8).

With reference to FIG. 7, the plurality of folding walls can include a bottom wall member 204, a rear wall member 206, a left wall member 208, and a right wall member 210. The extender 200, optionally, can also include an upper cover member 212.

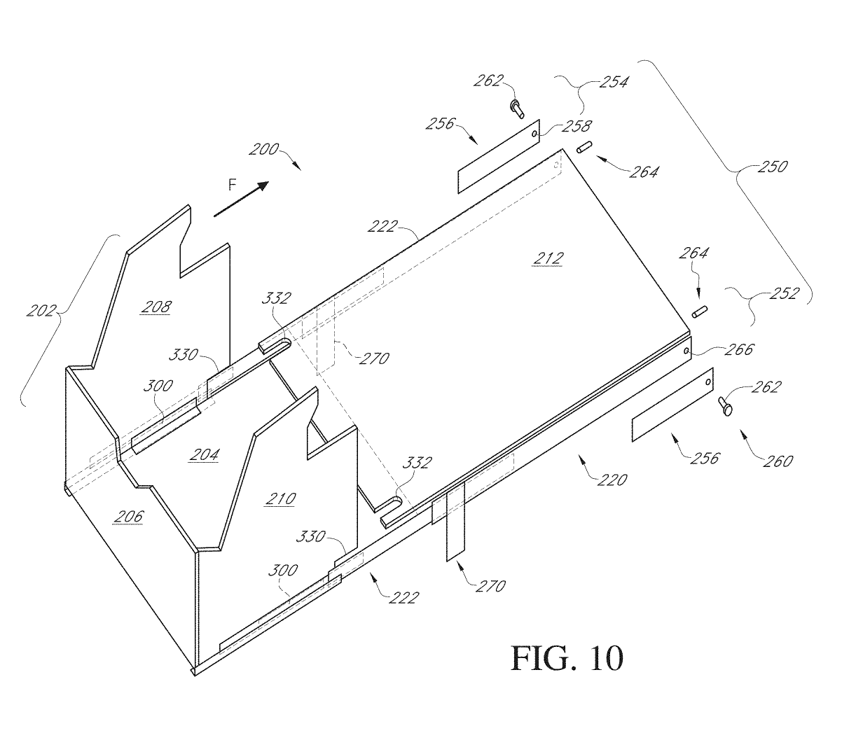

FIG. 10 illustrates a partially exploded view of the extender 200 removed from the vehicle 50. As shown in FIG. 10, the cargo extender 200 includes a mounting mechanism 220 that is configured to mount the extender 200 to the interior of the vehicle 50. Additionally, the mounting mechanism 220 includes a linear guide mechanism 222 configured to guide the plurality of folding walls 202 along a liner direction from a stowed position (FIG. 4) to an extended position (FIG. 5).

In some embodiments, the linear guide mechanism is in the form of mechanisms known as “drawer sliders” which can be in form of partial-extension or full-extension drawer slides. The illustrated embodiment of the liner guide mechanism 222 is in the form of a full extension drawer slide. Thus, in accordance with known designs for drawer slides, the liner guide mechanism 222 includes a first slide portion 224 fixed relative to the vehicle 50 in at least one dimension (described in greater detail below), an intermediate telescoping member 226 and a third member 228 fixed to the plurality of folding walls 202. The illustrated embodiment, the third member 228 is attached directly to the bottom floor member 204.

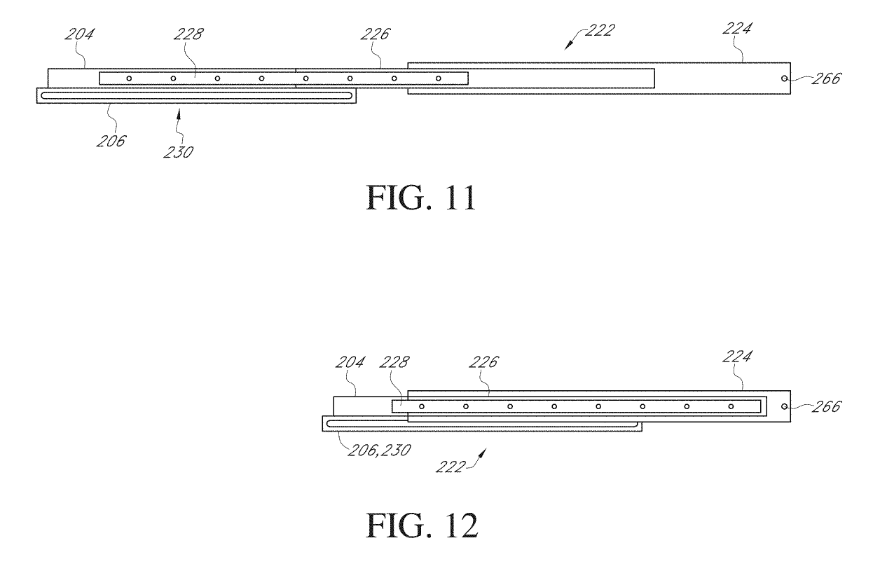

FIGS. 11 and 12 illustrate the linear guide mechanism to 222 in the opened and closed positions, respectively, and removed from the other components of the cargo hold extender 200 and the vehicle 50.

As shown in FIG. 12, in the closed position, the intermediate member 226 and third member 228 are nested with the first drawer slide member 224 in the closed position. Thus, in side elevational view of FIG. 12, the position of the bottom member 204 of the plurality of folding walls 202 overlaps the first member 224 of the linear guide mechanism 222. On the other hand, in the open position, with the bottom member 204 pulled to the extended position (FIG. 11), the intermediate member 226 and third member 228 extend outwardly, in a telescoping manner, from a rear end of the first drawer slide member 224.

As typical with slider configurations, a drawer slider mechanism 222, as described above, can be provided on both the left and right sides of the cargo hold extender 200 connected to the left and right sides of the bottom member 204.

Optionally, the plurality of folding walls 202 can be configured such that the wall 206 can be stored below and parallel to the bottom wall 204. For example, the plurality folding wall 202 can include a guide slot member to 230 attached to a lower surface of the bottom member 204.

For example with reference to FIGS. 20 and 20A the guide slot member 230 can have a generally channel shaped configuration with an upper wall 232, a lower wall 234 and a center wall 236. The walls 232, 234, 236 can be oriented, as noted above, in a channel type configuration with the wall 236 forming the bight of the channel shape. Additionally, the center wall 236 can include a guide slot 238. The guide slot 238 can define a linear sliding path for the rear wall 206.

For example, with reference to FIG. 20, the rear wall 206 can include a guide pin 240 attached at a bottom corner of the rear wall 206. The guide pin 240 can include a shaft portion extending through the slot 238 and an enlarged head disposed on an outer side of the center wall 236 of the guide slot member 230. Additionally, the spacing between the lower 234 and the upper wall 232 of the guide slot member 230 (FIG. 20A) can be approximately the same as or slightly larger than the thickness of the rear wall 206. Thus, to stow the rear wall 206 under the bottom member 204, the rear wall 206 can be rotated downwardly from the position illustrated in FIG. 20, along the arrow S, until it is approximately parallel with the bottom wall 204 then slid into the space between the upper wall 232 and lower wall 234 of the guide slot member 230. The rear wall 206 can then be pushed rearwardly underneath the bottom wall 204 until it is in the positions illustrated in FIGS. 11, 12, and 14. As such, the guide slot member 230 also defines a hinge, hingedly connecting the rear wall 206 to the bottom wall 204.

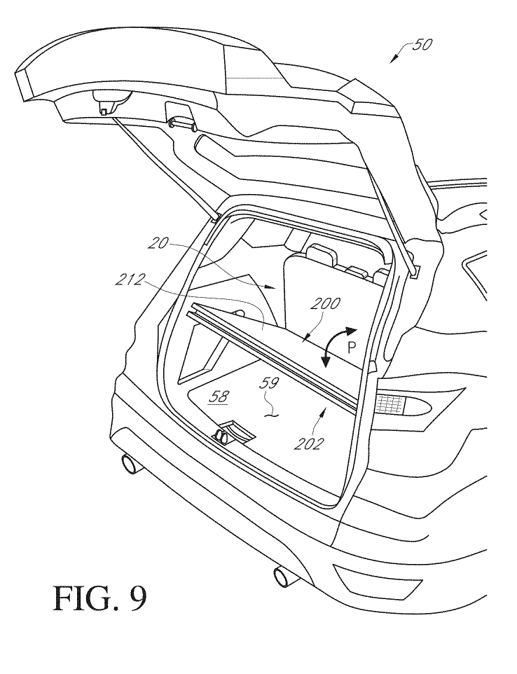

With reference again to FIG. 10, the cargo extender 200 can optionally be mounted within the vehicle 50 for pivoting movement for allowing access to an area below the cargo extender 200, for example, when it is in a retracted and stowed position. For example, with reference to FIG. 9, the vehicle 50 can include a floor 58 of the cargo hold 20. In some vehicles, the floor 58 can include an openable access panel 59 under which equipment can be stored. For example, such equipment can include a spare tire, jack, tools, spare fuses, etc. Thus, by mounting the cargo hold extender 200 to be pivotable, for example, in the direction of arrow P (FIG. 9) the extender 200 can be conveniently pivoted out of the way and allow access to the floor 58 and the access panel 59. The extender 200 can be modified for pivoting about for other axes, depending on the design of the floor 58 of the associated vehicle 50.

With reference again to FIG. 10, the mounting mechanism 220 can include a pivot mechanism 250 configured for pivotally mounting the extender 200 about an axis extending generally horizontally, along a forward most edge of the extender 200. In the illustrated embodiment, the pivot mechanism 250 includes a right side pivot 252 and a left side pivot 254. Although the right side pivot 252 is described below, the description thereof applies equally to the left side pivot 254.

The pivot mechanism 250 can include a mounting member 256. The mounting member 256 illustrated in FIG. 10 is a schematic representation of a mounting member that can be used with the pivot mechanism 250. The mounting member 256 can be configured to be secured to the cargo hold 20 of a vehicle 50, either to a side wall, bottom wall, or forward wall thereof. In some embodiments, the location for securing the mounting member 256 could be a wheel well, or other curved or flat surfaces. Thus, the mounting member 256 can have any shape that would cooperate with an internal surface with sufficient strength for mounting of the extender 200. The mounting member 256 can be in the form of a flat bar, angle, channel, rod, cylinder, or rectangular tubed material. In some installations, the mounting member 256 can be screwed to the underlying sheet metal within the cargo hold 20. Further, in some mounting arrangements, such sheet metal may be covered with adhesives, carpet, or plastic sheathing.

The mounting member 256 can include a pivot aperture 258. The pivot aperture 258 thus can define a pivot axis 260 for the pivoting movement of the extender 200 in the direction of arrow P (FIG. 9).

Pivot pins 262 can optionally be formed of cooperating bolts and washers 264 used for mounting the extender 200 pivotally to the pivot apertures 258. For example, in some embodiments, with reference to FIGS. 11 and 12, the linear guide mechanism 222 can include pivot apertures 266 positioned to be aligned with pivot apertures 258 and pins 262. As such, the liner guide mechanism 222, as well as the attached set of folding walls 202 can pivot about the axis 260.

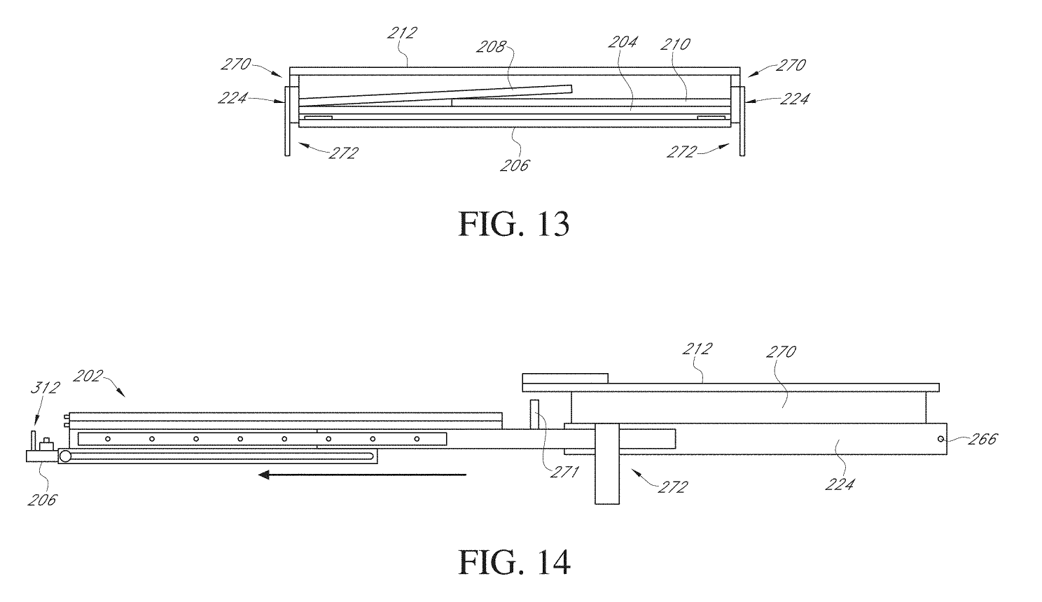

Further, as noted above, the cover member 212 of the extender 200 can be disposed above the plurality of folding walls 202 when in the stowed position (FIG. 12). For example, in some embodiments, with reference to FIGS. 10, 13, and 14, the cover member 212 can be mounted to the linear guide mechanism 222 with a spacer 270. The spacer 270 can be sized to provide sufficient clearance between lower surface of the cover member 212 and the plurality of folded walls 202 when in the folded and stowed state, (as shown in FIGS. 13 and 14). Thus, the cover member 212 along with the plurality of folding walls 202, can pivot together about the axis P (FIG. 9).

With continued reference to FIG. 14, the extender 200 can optionally include a retaining wall fixed to a forward portion of the bottom wall 24, configured to prevent items from inadvertently falling off of the forward-most edge of the bottom wall 204, for example, when the extender is in the deployed position. For example, the wall 271 can have a height about the same size as the distance between the lower surface of the floor member 212 and the upper surface of the bottom wall 204. Other devices can also be used for such purposes.

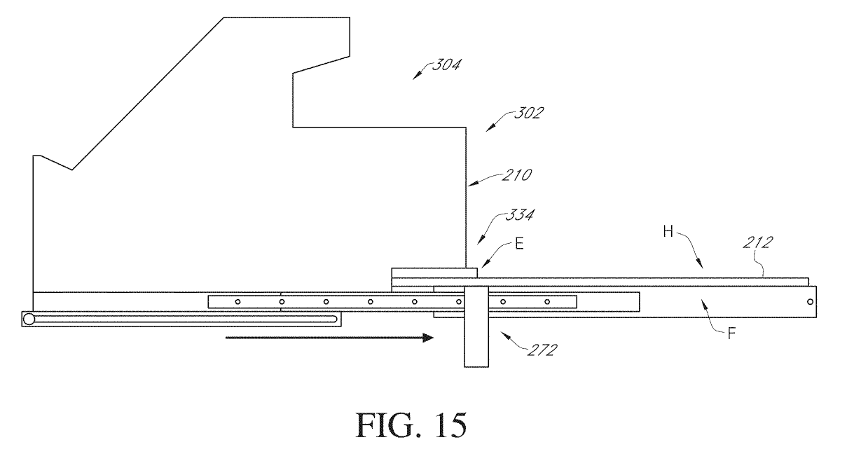

Optionally, with reference to FIGS. 10 and 13-15, the extender 200 can include support legs 272 configured to support the extender 200 at a desired angle relative to the floor 58 of the associated cargo hold 52. For example, the legs 272 can be sized so as to maintain an upper surface of the cover member 212 in a generally horizontal orientation when the associated vehicle 50 is on horizontal ground. With continued reference to FIGS. 10 and 15, the side walls 208, 210 can be attached to the floor member 204 with hinges 300 (FIG. 10). The hinges 300 can be any type of hinge. In some embodiments, the hinges 300 are piano hinges. In some embodiments, the hinges 300 are mounted to the inwardly facing surfaces of the side walls 208, 210. As such, the hinges would normally cause the edges of the side wall 208, 210 to contact an upper surface of the bottom wall 204 when in the vertical or deployed position illustrated in FIGS. 10 and 15. Other hinge arrangements can also be used.

With continued reference to FIG. 15, the side walls can include a forward portion 302 configured to extend through the hatch aperture 62 of the associated vehicle and overlap an upper surface of the cover member 212. Further, an upper portion of the side walls 208, 210 can include a cutout portion 304 shaped to fit around a narrowing area of the hatch aperture 62 and to extend around the hatch aperture 62 onto an outside portion of the hatch aperture 62 as illustrated in FIG. 7. Further, as shown in FIG. 7, the cutout 304 extends around a portion of the hatch aperture 62 in an upper area of the hatch aperture which narrows in the width direction of the vehicle.

In some embodiments, the side walls 208, 210 are flat and vertical when in the deployed position. A flat configuration of the side walls 208, 210 provides the added benefit of achieving a compact arrangement when folded for stowage in the stowed position. However, because many vehicles, such as the vehicle 50, include non-rectangular hatch apertures 62, many of which narrow in an upper area, the cutout portion 304 better accommodates such narrowing in the upper portion of the hatch aperture 62. An upper part 306 of the cut out 304 can extend on an outside of the gasket 72 into a position in the vicinity of the hinge of the hatch 60 (not shown).

The walls 208, 210 can include an upper edge 308 that is configured to follow corresponding contours on the inwardly facing side 90 when the hatch 60 is in a position resting against overall upper edge of the extender 200. Similarly, the rear wall 206 includes an upper edge 310 that is also configured to follow the contours of the inner side 90 of the hatch 60 when the hatch 60 is pressed against the upper edge of the extender 200.

In some embodiments, the upper edge 310 of rear wall 206 includes a locking stud 312 configured to engage with the hatch lock 82. In some embodiments, depending on the type and orientation of the lock 82, the locking stud 312 can be in the form of a short metal rod or a loop.

The position of the rear wall 602 can be determined by the position of the lock 82 when the hatch 60 is in the desired final position such as that illustrated in FIG. 8, locked to the rear wall 206 with the lock 82 engaged with the locking stud 312. For example, in the design of the shape of the extender 200, the designer can choose the orientation at which the hatch should be positioned when it is in its closed position such as that illustrated in FIG. 8. The final position of the hatch 60 can be that which provides sufficiently desirable aerodynamics, e.g., with the hatch oriented such that it does not extend above the roof of the associate vehicle 50. Alternatively, the final position can be chosen based on providing visibility of the center tail light disposed in an upper portion of the rear window of the hatch 60. The final position of the hatch may be chosen to be in other orientations.

Optionally, the upper edge 308 of the side walls 208, 210 and the upper edge 310 of the rear wall 206 can include gasket members (not shown) for enhancing a sealing effect between the inner portion of the hatch 90 and the upper edges 308, 310. Gasket materials typically used in automotive applications can be used for such gaskets. Other gaskets can also be used.

With reference to FIGS. 10 and 15, a lower portion of the side walls 208, 210 can include cut outs 330 to accommodate an overlapping of the side walls 208, 210 with the cover member 212. Further, the cover member 212 can optionally include corresponding cutouts 332 aligned with the cutouts 330. Such cutouts 330, 332 can aid in securing a vertical orientation of the forward edges of the side walls 208, 210 when in a deployed and engaged position. Further, the extender 200 can include side wall alignment guides 334 (FIGS. 7, 15, and 19).

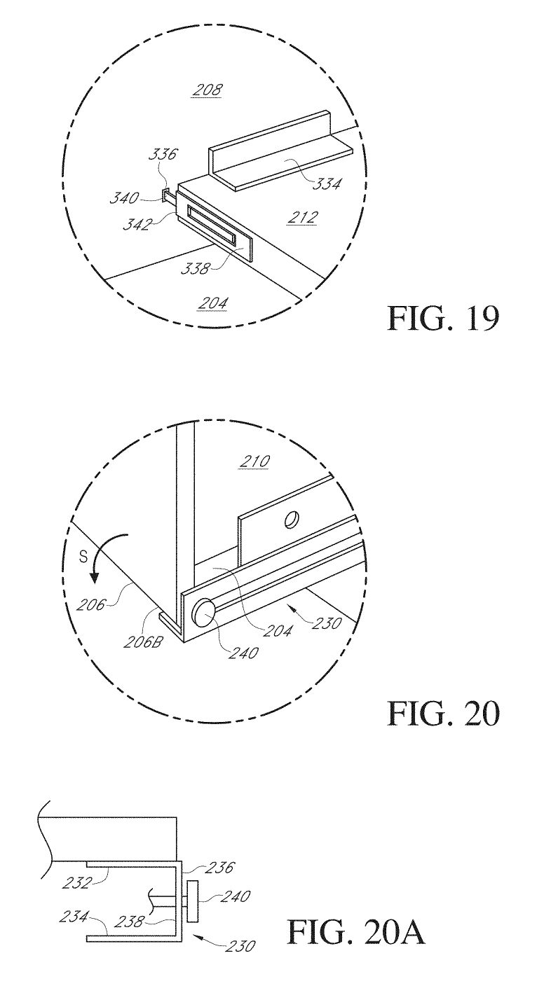

With reference to FIGS. 13 and 19, the cargo hold extender 200 can also include side wall locks. For example, as shown in FIG. 19, the side wall 208 can include a side wall aperture 336 and a slide bolt mechanism 338 including a slide bolt 340 mounted within a housing 342. The housing can be mounted to a rear edge of the cover member 212 so as to retain the bolts in a limited range movement, wherein in the extended position, the bolt 340 extends into the aperture 336. The lock mechanism 338 can include a detent or other latching mechanism for retaining the bolt 340 in the opened and extended positions. Other types of locks can also be used. Another lock 338 can also be disposed on the right side of the cargo extender for engagement with the wall 210.

In some embodiments, the extender 200 can also include alignment mechanisms for aligning the right and left edges of the rear wall 206 with the rear edges of the side walls 208, 210. For example, with reference to FIG. 18, the rearward edge of the wall 210 includes alignment posts 340 and the right edge of the rear wall 206 includes alignment apertures 342 in positions corresponding to the alignments pins 340. The apertures and pins 342, 340 are positioned such that when the rear wall 206 is pivoted upwardly into contact with the rear edges of the side walls 208, 210, the alignment pins 340 are received within the alignment apertures 342.

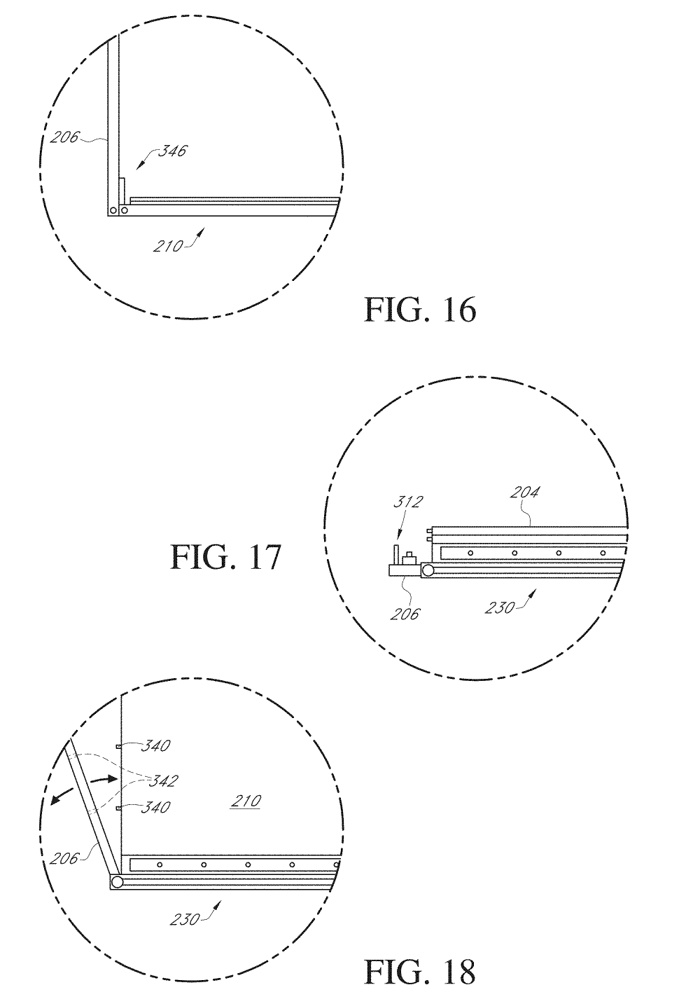

With reference to FIG. 16, the cargo extender 200 can optionally include a latch mechanism 346. For example, the latch mechanism 346 can be mounted to a forwardly facing surface of the rear wall 206 (when in the deployed position of FIG. 10). Similarly to the lock mechanism 338 (FIG. 19), the latch mechanism 346 can include a housing and a bolt configured to the movable to a retracted and extended position. In the extended position, the bolt extends into a corresponding aperture in the side wall 210, thus securing the rear wall 206 to the side wall 210. The rear wall can include a second latch 346 for securing to the side wall 208.

Constructed as such, the cargo hold extender 200 can be stored within a cargo hold of a vehicle 50, in the orientation illustrated in FIG. 4. This orientation can be referred to as a stowed position, with the plurality of folding walls 202 disposed under the cover member 212 and with the entire extender 200 disposed entirely within the cargo hold 20 such that the hatch 60 can be closed normally with its lock 82 engaged with the lock stud 84.

To use the extender 200 for extending the volume of the cargo hold 20, the user would open the hatch 60, as shown in FIG. 4 then pull the plurality of walls 202 rearwardly, in the direction of arrow R so to pull the plurality of folding walls 202 to the extended position (FIG. 5). FIG. 14 also illustrates the extended position of the extender 200, removed from the vehicle 50.

Then, the user could unfold the side walls 208, 210 to move them to the deployed positions (FIG. 6) in which they would extend generally perpendicular to the bottom wall 204. The user can then push the deployed side walls 208, 210, along with the bottom wall 204 toward the vehicle 50, so as to engage the cutouts 330, 332. Further, the user can lock the locking mechanisms 338 (FIG. 19) to secure the bottom wall 204 and side walls 208, 210 in place.

The user can then pull the rear wall 206 rearwardly, along the direction of arrow E extending the rear wall 204 to the phantom illustrated position in FIG. 7. Then the user could rotate or pivot the rear wall 206 upwardly, along the direction of arrow P, moving the alignment apertures 342 onto the alignment pins 340 (FIG. 18). Latches 346 (FIG. 16) can be secured for connecting the rear wall 206 to the side walls 208, 210. At this point, the cargo extender would be positioned in the position illustrated in FIG. 7.

Then the user can push the tailgate 60 downwardly, towards the position illustrated in FIG. 8, in which the lock 82 of the hatch 60 engages the lock stud 312 of the rear wall 206. In this position, the lock 82 of the hatch 60 provides a further securing engagement of the extender 200 to the vehicle 50. Additionally, as described above, the upper edges 308 of the side walls 208, 210 and the upper edge 310 of the rear wall 206 can include a gasket for following along the contours of the inner part 90 of the hatch 60 which contact the upper edges 308, 310. Thus, the cargo hold extender can form a substantially sealed enclosure and extension of the original cargo hold 20 of the vehicle 50.

It is understood that while certain forms of the inventions have been illustrated and described, they are not limited thereto.

What is claimed is:

1. A cargo area extender for a vehicle having an enclosed, hatched cargo area having a hatch aperture and an upwardly opening hatch member, the extender comprising:
a set of folding walls comprising a bottom wall, a rear wall, a left side wall and a right side wall, the rear wall being hingedly connected to the bottom wall with a first hinge, the left side wall being hingedly connected to the bottom wall with a second hinge, and the right side wall being hingedly connected to the bottom wall with a third hinge;
a mounting mechanism secured to the bottom wall and to an interior of the enclosed, hatched cargo area, the mounting mechanism comprising a first linear guide mechanism configured to guide the bottom wall along a first linear direction from a stowed position with the set of folding walls disposed entirely within the enclosed, hatched cargo area to an extended position in which the bottom wall extends outwardly through the hatch aperture, the mounting mechanism further comprising a pivot configured to allow the set of folding walls to be pivoted about a horizontal axis when in the stowed position;
wherein the rear wall comprises a lower rear edge connected to the first hinge and an upper edge, the upper edge having a first shape and a first gasket member extending along the first shape and configured to abut against a lower sealing edge of the hatch, the rear wall further comprising a lock member configured to engage a lock on the lower portion of the hatch when the rear wall is in a deployed position and the hatch is pushed against the upper edge of the rear wall;
wherein the left side wall comprises a left side lower edge connected to the second hinge and a left side upper edge, the left side upper edge having a second shape and a second gasket extending along the second shape and configured to abut against a left side contour of the hatch when the left side wall is in a deployed position and the hatch is pushed downwardly toward the left side upper edge;
wherein the right side wall comprises a right side lower edge connected to the third hinge and a right side upper edge, the right side upper edge having a third shape and a third gasket member extending along the third shape and configured to abut against a right side contour of the hatch when the right side wall is in a deployed position and the hatch is pushed downwardly toward the left side upper edge; and
a floor member mounted to the pivot of the mounting mechanism, the floor member disposed above the bottom wall when the bottom wall is in the stowed position, defining a floor of the enclosed, hatched cargo area and being fixed along the first linear direction such that the set of folding walls can be translated along the first linear direction while the floor member remains stationary.

2. The cargo area extender according to claim 1 additionally comprising a left lock and a right lock, the left and right locks configured to releasably lock the rear wall to the left and right side walls, respectively.

3. The cargo area extender according to claim 1 additionally comprising a left side wall lock and a right side wall lock, the left side wall lock and the right side wall lock configured to releasably lock to the floor member when the left and right side walls are in a deployed position and partly overlapping an upper surface of the floor member.

4. The cargo area extender according to claim 1 additionally comprising a plurality of alignment posts extending rearwardly from a rear edge of the left and right side walls and a plurality of alignment post apertures disposed along left and right edges of the rear wall, the plurality of alignment posts configured to extend into the plurality of alignment post apertures when the left and right side walls and rear wall are in the deployed positions.

5. A cargo area extender for a vehicle having an enclosed, hatched cargo area having a hatch aperture and an upwardly opening hatch member, the extender comprising:
a set of folding walls comprising a bottom wall, a rear wall, a left side wall and a right side wall, the rear wall being hingedly connected to the bottom wall with a first hinge, the left side wall being hingedly connected to the bottom wall with a second hinge, and the right side wall being hingedly connected to the bottom wall with a third hinge;
a mounting mechanism secured to the bottom wall and configured to be secured to an interior of an enclosed, hatched cargo area of a vehicle in use, the mounting mechanism comprising a first linear guide mechanism configured to guide the bottom wall along a first linear direction from a stowed position with the set of folding walls disposed entirely within the enclosed, hatched cargo area to an extended position in which the bottom wall extends outwardly through the hatch aperture;
wherein the rear wall comprises a lower rear edge connected to the first hinge and an upper edge, the upper edge configured to abut against a lower sealing edge of the hatch, the rear wall further comprising a lock member configured to engage a lock on the lower portion of the hatch when the rear wall is in a deployed position and the hatch is pushed against the upper edge of the rear wall;
wherein the left side wall comprises a left side lower edge connected to the second hinge and a left side upper edge, the left side upper edge configured to abut against a left side contour of the hatch member when the left side wall is in a deployed position and the hatch member is pushed downwardly toward the left side upper edge;
wherein the right side wall comprises a right side lower edge connected to the third hinge and a right side upper edge, configured to abut against a right side contour of the hatch member when the right side wall is in a deployed position and the hatch member is pushed downwardly toward the left side upper edge; and
a floor member mounted to the mounting mechanism, the floor member disposed above the bottom wall when the bottom wall is in the stowed position, defining a floor of the enclosed, hatched cargo area and being fixed along the first linear direction such that the set of folding walls can be translated along the first linear direction while the floor member remains stationary.

6. The cargo area extender according to claim 5, wherein the left side upper edge comprises a second shape and a second gasket extending along the second shape, the second gasket configured to abut against a plurality of contours of the left side contour of the hatch, wherein the right side upper edge comprises a third shape and a third gasket extending along the third shape, the third gasket configured to abut against a plurality of contours of the right side contour of the hatch member, and wherein the rear wall has a rear upper edge having a first shape and a first gasket member extending along the first shape, the first gasket configured to abut against the lower sealing portion of the hatch member.

7. The cargo area extender according to claim 5, wherein the mounting mechanism further comprises a pivot configured to allow the floor member and set of folding walls to be pivoted about a horizontal axis when in the stowed position, for allowing access to an area disposed beneath the set of folding walls when in the stowed position.

8. The cargo area extender according to claim 5, additionally comprising a spacer configured to support the floor member above the bottom wall by a first spacing, the first spacing being larger than a thickness of the first and second side walls.

9. The cargo area extender according to claim 5 additionally comprising a loop member extending upwardly from the upper edge of the rear wall when in a deployed position, the loop member configured to engage the lock on the hatch member.

10. The cargo area extender according to claim 5 additionally comprising a left lock and a right lock, the left and right locks configured to releasably lock the rear wall to the left and right side walls, respectively.

11. The cargo area extender according to claim 5 additionally comprising a left side wall lock and a right side wall lock, the left side wall lock and the right side wall lock configured to releasably lock the left and right side walls, respectively, to the floor member when the left and right side walls are in a deployed position and partly overlapping an upper surface of the floor member.

12. The cargo area extender according to claim 5 additionally comprising a plurality of alignment posts extending rearwardly from a rear edge of the left and right side walls and a plurality of alignment post apertures disposed along left and right edges of the rear wall, the plurality of alignment posts configured to extend into the plurality of alignment post apertures when the left and right side walls and rear wall are in deployed positions.

13. A cargo area extender for a vehicle having an enclosed, hatched cargo area having a hatch aperture and an upwardly opening hatch member, the extender comprising:
a set of folding walls comprising a bottom wall, a rear wall, a left side wall and a right side wall, the set of folding walls being foldable between a folded position and an unfolded position;
a mounting mechanism secured to the bottom wall and to an interior of the enclosed, hatched cargo area, the mounting mechanism comprising a first linear guide mechanism configured to guide the bottom wall along a first linear direction from a stowed position with the set of folding walls disposed entirely within the enclosed, hatched cargo area to an extended position in which the bottom wall extends outwardly through the hatch aperture;
wherein the rear wall comprises an upper edge configured to abut against a lower sealing edge of the hatch member when the set of folding walls is in the extended position and when the rear wall is in the unfolded position.

14. The cargo area extender according to claim 13, wherein when in the unfolded position, the bottom wall, rear wall, left side wall and right side wall define a trough-shaped extension extending through a hatch aperture of a cargo area of a vehicle having an enclosed, hatched cargo area.

15. The cargo area extender according to claim 13, wherein the rear wall further comprises a lock member configured to engage a lock on the lower portion of the hatch when the rear wall is in the unfolded position and the hatch is pushed against the upper edge of the rear wall,

16. The cargo area extender according to claim 13, wherein the left side wall comprises a left side lower edge connected to a second hinge and a left side upper edge, the left side upper edge configured to abut against a left side contour of the hatch member when the left side wall is in a deployed position and the hatch member is pushed downwardly toward the left side upper edge and wherein the right side wall comprises a right side lower edge connected to a third hinge and a right side upper edge, configured to abut against a right side contour of the hatch member when the right side wall is in a deployed position and the hatch member is pushed downwardly toward the left side upper edge.

17. The cargo area extender according to claim 13 additionally comprising a floor member mounted to the mounting mechanism, the floor member disposed above the bottom wall when the bottom wall is in the stowed position, defining a floor of the enclosed, hatched cargo area and being fixed along the first linear direction such that the set of folding walls can be translated along the first linear direction while the floor member remains stationary.

18. The cargo area extender according to claim 13, wherein the rear wall is hingedly connected to the bottom wall with a first hinge, the left side wall is hingedly connected to the bottom wall with a second hinge, and the right side wall is hingedly connected to the bottom wall with a third hinge.

19. The cargo area extender according to claim 16, wherein the left side upper edge comprises a second shape and a second gasket extending along the second shape, the second gasket configured to abut against a plurality of contours of the left side contour of the hatch, wherein the right side upper edge comprises a third shape and a third gasket extending along the third shape, the third gasket configured to abut against a plurality of contours of the right side contour of the hatch member, and wherein the rear wall has a rear upper edge having a first shape and a first gasket member extending along the first shape, the first gasket configured to abut against the lower sealing portion of the hatch member.

20. The cargo area extender according to claim 13, wherein the mounting mechanism further comprises a pivot configured to allow the set of folding walls to be pivoted about a horizontal axis when in the stowed position, for allowing access to an area disposed beneath the set of folding walls when in the stowed position.

21. The cargo area extender according to claim 13, additionally comprising a spacer configured to support a floor member above the bottom wall by a first spacing, the first spacing being larger than a thickness of the first and second side walls.

22. The cargo area extender according to claim 13 additionally comprising a left lock and a right lock, the left and right locks configured to releasably lock the set of folding walls in the stowed position under a floor member.

23. The cargo area extender according to claim 13 additionally comprising a left side wall lock and a right side wall lock, the left side wall lock and the right side wall lock configured to releasably lock to the left and right side walls to a floor member when the left and right side walls are in a deployed position and partly overlapping an upper surface of the floor member.

24. The cargo area extender according to claim 13 additionally comprising a plurality of alignment posts extending rearwardly from a rear edge of the left and right side walls and a plurality of alignment post apertures disposed along left and right edges of the rear wall, the plurality of alignment posts configured to extend into the plurality of alignment post apertures when the last and right side walls and rear wall are in deployed positions.
